(19) United States
(12) Patent Application Publication
(10) Pub. No.: US 2011/0165793 A1
(43) Pub. Date: Jul. 7, 2011

(54) Waterproof Insulated Connector

(76) Inventor: Gang Zhou, Chengdu (CN)

(21) Appl. No.: 13/003,375

(22) PCT Filed: Jul. 9, 2009
(86) PCT No.: PCT/CN2009/072705

§ 371 Date: Jan. 10, 2011

(30) Foreign Application Priority Data
Jul. 10, 2008 (CN) 200810045509

(51) Int. Cl. H01R 13/52

(52) U.S. Cl. 439/589

(57) ABSTRACT

The invention involves relates to a waterproof insulated connector, which improves any electrical connection of a power supply, a USB, a VGA, a socket of electric equipment, an SD, an MS, an MMC and the like into a connection which can realize water-proof and insulation performances completely. Whether a connector of the electric equipment is connected or not, the plug and the socket are waterproof and can be directly connected in water or other media absolutely without damaging the electric equipment and causing electric shock accidents, and the multi-connection can realize mutual isolation. The waterproof performance is realized by an isolating cavity consisting of a gating isolate component made of a dielectric elastomer, a shell and a hollow waterproof ring. The waterproof isolation connector and the method thereof have innovation in technology and lead users to an electric world with high safety and humanization.

### THE TECHNICAL FIELD

The invention relates to a waterproof insulated connector, which improves any electric connection of a power supply, a USB, a VGA, a socket of electric equipment, an SD, an MS, an MMS and the like into a connection which can realize water-proof and insulation performances completely. Whether a connector of the electric equipment is connected or not, the plug and the socket are waterproof and can be directly connected in water or other media absolutely.

### BACKGROUND

Current so-said waterproof connection is realized by the encapsulated connection made f the plug and the socket (female parts and male parts). That is, when the plug is not connected, it is not waterproof, as described in China Utility Model Patents ZL03228669.4 (FIG. 2), ZL03228668.6 (FIG. 3), ZL03229142.6 (FIG. 4), and ZL200520116143.0 (FIG. 6), Invention Patent Applications 200610093084.3 (FIG. 5), 200710028526.0 (FIGS. 7), and 95106652.8 (FIG. 9), and Invention Patent ZL01123034.7 (FIG. 8).

Waterproof insulated connector disclosed in the invention is featured by that, whether the plug and the socket are connected, they are waterproof and can be directly connected in water or other media absolutely without damaging the electrical equipment or causing electric shock accidents, and the multi-connection can realize mutual isolation. The waterproof performance is realized by an isolating cavity consisting of a gating isolate component made of moving conductors and a dielectric elastomer, a shell and a hollow waterproof ring.

The waterproof isolation connector disclosed in the invention and the manufacturing method thereof have innovation in technology and substantial differences from the existing technologies. It will lead us into an electric world with high safety and humanization.

### SUMMARY OF INVENTION

Purpose of the invention is to provide a type of waterproof insulated connector, with which the electrical devices (mobile phone, computer, electrical appliances and the like) are completely waterproof whether they connect with other electrical devices. The plug and the socket of the electrical devices can operate normally in water or other media whether they are connected so as to realize direct waterproof insulated connection of electrified devices in water or other media, and the multi-connection can realize mutual isolation.

Technical scheme of the invention is as follows:

A type of waterproof insulated connector, which is characterized in that: such waterproof insulated connector consists of a gating isolate component made of conductor and dielectric elastomer, isolate contacts of the gating isolate components, and an isolating cavity. The gating isolate component isolates passing of water and other media and solely allows conduction of electricity through the conductor. In addition, the component may be subject to elastic deformation to move the moving conductor within the elastic deformation range of the dielectric elastomer, so as to realize disconnection and connection between the moving conductor and contact. Contact connects with the object with which the interface connects. The isolating cavity is composed of an elastic deformation device made of a solid body and an elastomer and surrounds the connector.

The additional technical scheme of the invention is as follows:

Preferably, if the dielectric elastomer in the said gating isolate component undergoes a pressure less than the push, it remains in the position of preliminary balance; if a pressure bigger than the push, it remains in the position of the final balance and the isolating water or other media contacts with the object contacted.

The isolating cavity, consisting of a shell and a hollow waterproof ring, is deformed as the hollow water rings undergoes elastic deformation when connected, which isolates conductors. Conductors exert pressure on each other to promote the gating isolate component to enable the contact of the plug and the socket to conduct via conductors.

The said isolating cavity includes the shell and the elastomeric seal at the opening of the shell. The contact is installed inside the shell and connects with the object that is connected to the interface. The dielectric elastomer of the gating isolate component is fixed at the opening of the shell, and conductors are fixed on the elastomer and pass through it, which can contact or disconnect with the contact with the deformation of the dielectric elastomer. The gating isolate component and the shell embrace the contact completely.

Preferably, the said technical scheme may be applicable to electric equipment which includes the said waterproof insulated connector. The interface of the electric equipment connect with the outside via the waterproof insulated connector. The waterproof cavity is formed by the waterproof insulation layer and the shell of the connector to enfold the electric equipment.

The invention has the beneficial effects as follows: 1. The gating isolate component and the isolating cavity work together to isolate the contact of the plug and the socket to enable the electrical appliance to function well in water or other media, mainly due to the reason that the gating isolate component isolates the contact of the plug and the socket from the media to prevent lines of the plug and socket from mutual influences if the media is conducted. 2. Via the preliminary contact of the plug and the socket, the isolating cavity is formed to isolate conductors. The pressure is continued to realize the final contact of the plug and the socket, which enables the contract of the plug and the socket to realize the waterproof and insulated connection via the conduction of moving conductors. Thus the electrical appliance can be directly connected in water or other media without damaging it or electric shocks.

### DESCRIPTIONS OF DRAWINGS

The invention is described using examples shown in the drawings, among which

FIG. 1 is the schematic diagram of the waterproof insulated connector, the embodiment of the invention, in the preliminary contact status.

From FIG. 2 to FIG. 9 are the schematic diagrams of the waterproof insulated connector of the current technology.

FIG. 10 is the schematic diagram of the waterproof insulated connector of the embodiment in FIG. 1 in the final contact status.

FIG. 11 is the plan view of horizontal-pressure waterproof insulated connector, one embodiment of the invention.

FIG. 12 is the stereogram of the horizontal-pressure waterproof insulated connector shown in FIG. 10.

FIG. 13 is the schematic diagram of horizontal-pressure waterproof insulated connector, one embodiment of the invention being applied in battery.

FIG. 14 is the schematic diagram of the horizontal-pressure waterproof insulated connector shown in FIG. 12 in the preliminary contact status.

FIG. 15 is the schematic diagram of the horizontal-pressure waterproof insulated connector shown in FIG. 12 in the final contact status.

FIG. 16 is the multi-line application schematic diagram of horizontal-pressure waterproof insulated connector, one embodiment.

FIG. 17 is the stereogram of the embodiment shown in FIG. 16.

FIG. 18 is the schematic diagram of side-pressure waterproof insulated connector, one embodiment of the invention.

FIG. 19 is the stereogram of the embodiment shown in FIG. 18.

FIG. 20 is the multi-line application schematic diagram of side-pressure waterproof insulated connector, one embodiment of the invention.

FIG. 21 is the schematic diagram of cooperated utilization of electric equipment and the waterproof insulated connector, one embodiment of the invention.

### DETAILED DESCRIPTION OF THE EMBODIMENT

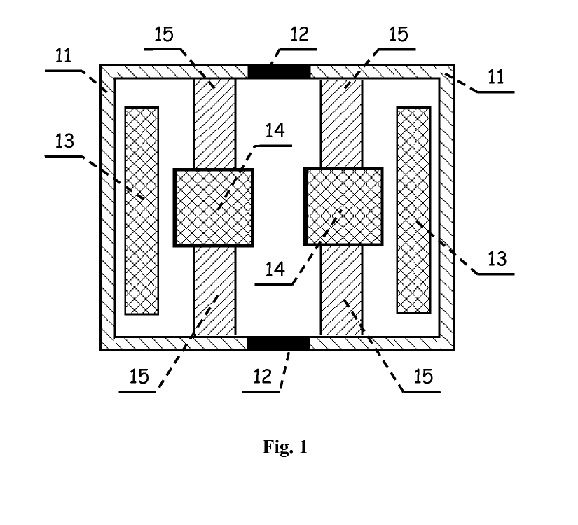

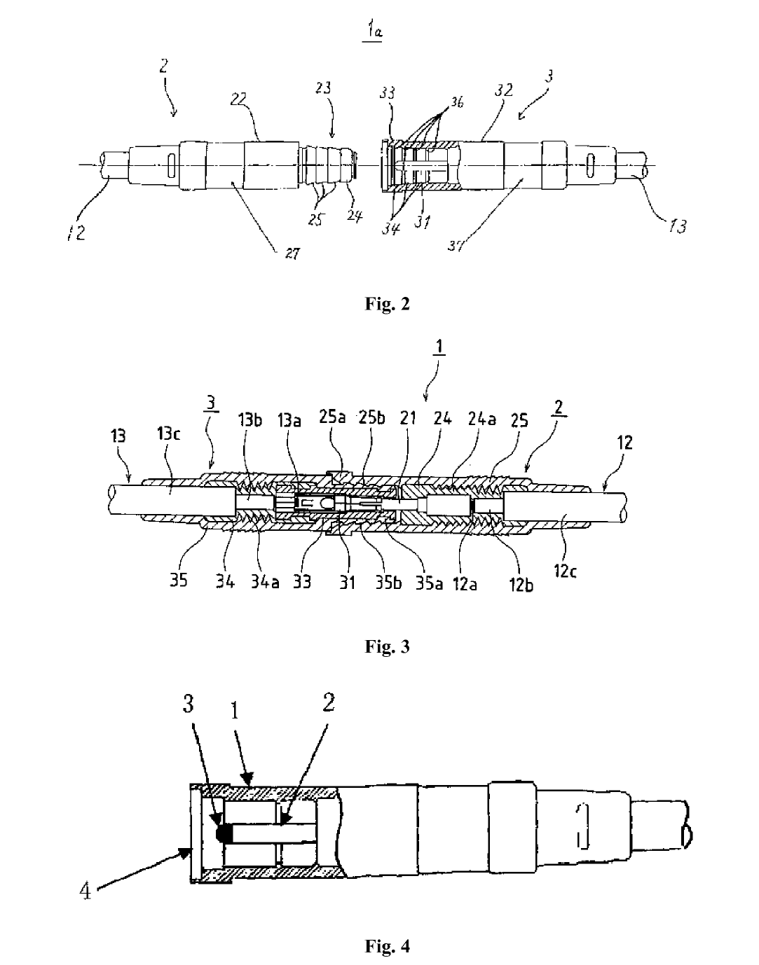

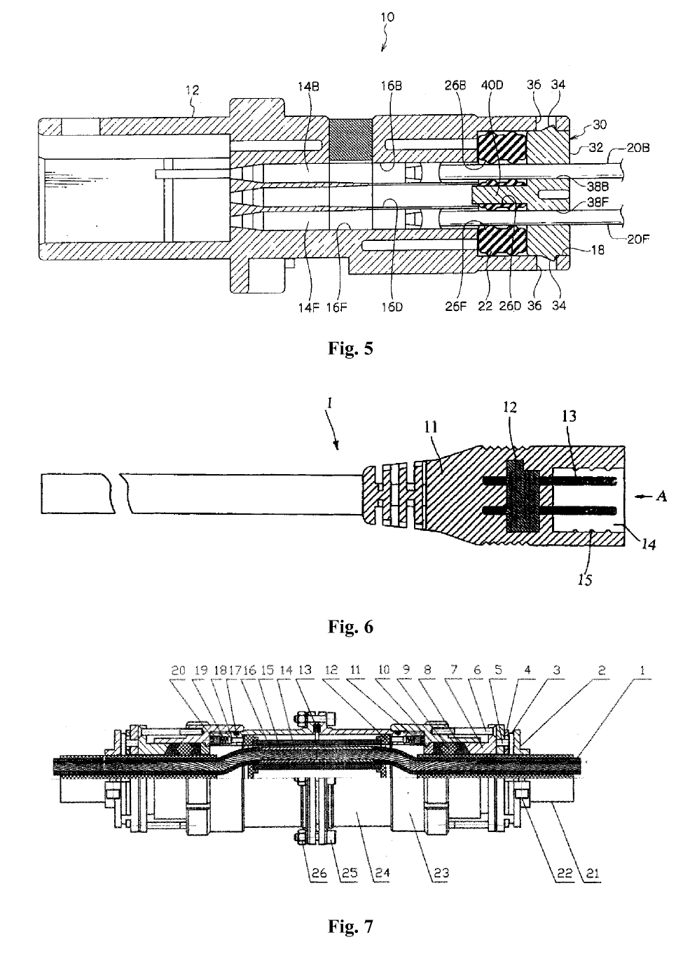

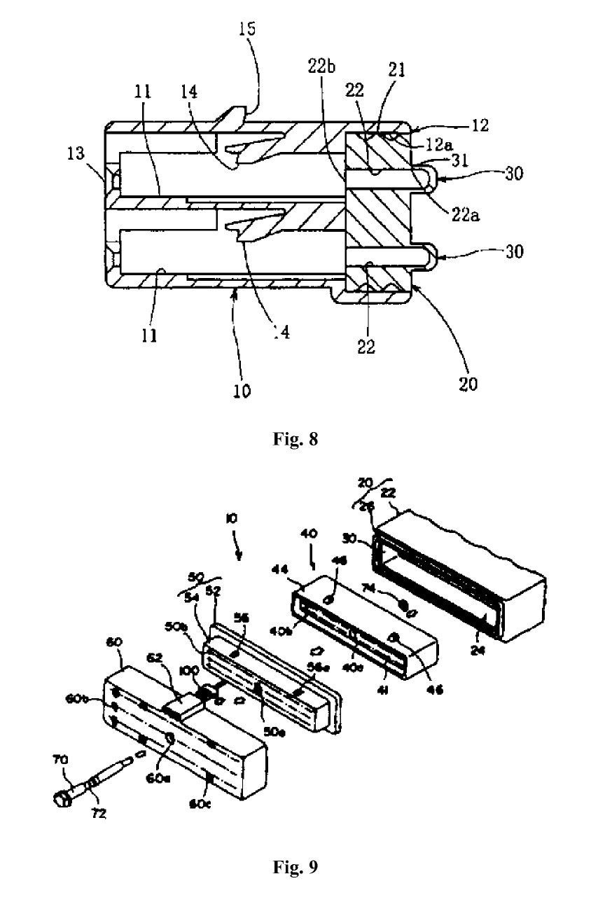

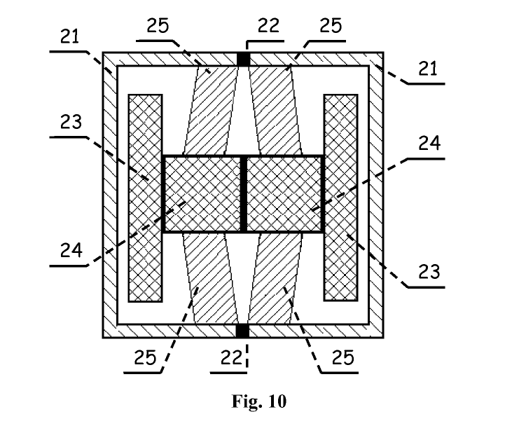

The specific embodiment 1 of the invention, as shown in FIG. 1, is a waterproof insulated connector with the shell 11. An elastomeric seal is fixed at the opening of the shell 11, and the contact 13 is installed inside the shell 11 and connects with the object that is connected to the interface. The dielectric elastomer 15 of the gating isolate component is fixed at the opening of the shell 11. Conductor 14 is fixed on the dielectric elastomer 15 and pass through it, which can contact or disconnect with the contact 13 with the deformation of the dielectric elastomer 15. The gating isolate component and the shell 11 embrace the contact completely. One preferable design of the said elastomeric seal is the adaptation of hollow waterproof ring 12, the isolating cavity of which will be deformed as the hollow water rings undergoes elastic deformation when connected. This isolates conductors 14, and conductors 14 exert pressure on each other to promote the gating isolate component to enable the contact 13 to realize waterproof and insulated connection via the conductions of conductors 14, as shown in FIG. 2.

Horizontal-pressure waterproof insulated connector embodiment of the invention, based on the embodiment 1.

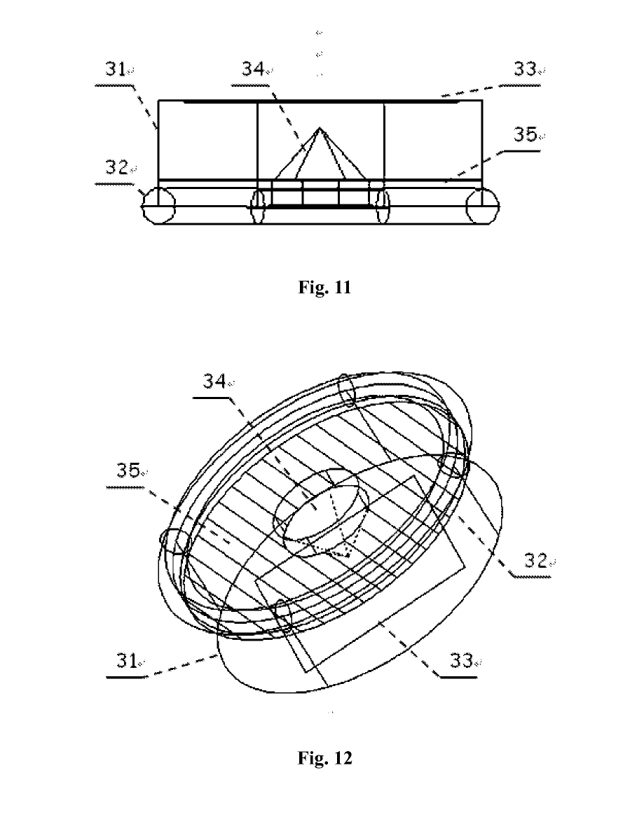

The horizontal-pressure waterproof insulated connector, as shown in FIG. 11, includes shell 31, hollow waterproof ring 32, contact 33, moving conductor 34, and dielectric elastomer 35. The structure of the horizontal-pressure waterproof insulated connector is clearly shown in FIG. 12, its stereogram, of which, the hollow waterproof ring 32 is installed at the opening of the shell 31; the contact 33 is installed inside the shell 31 and connects with the object that is connected to the interface; the dielectric elastomer 35 of the gating isolate component is fixed at the opening of the shell 31; Conductor 34 is fixed on the dielectric elastomer 35 and pass through it, which can contact or disconnect with the contact 33 with the deformation of the dielectric elastomer 35. The gating isolate component and the shell 31 embrace the contact completely.

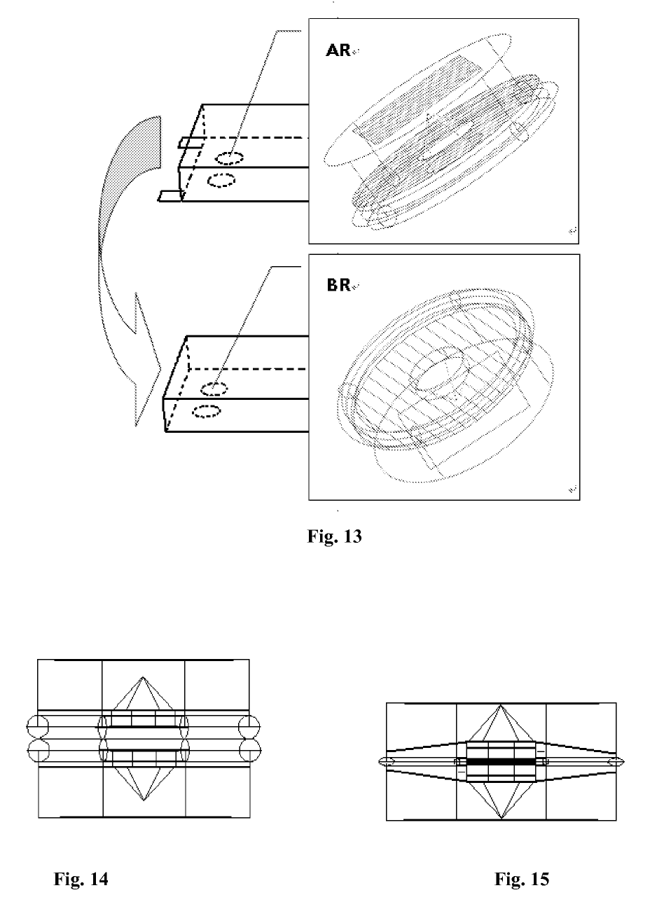

The actual application of the horizontal-pressure waterproof insulated connector is clearly shown in FIG. 13, the schematic diagram of horizontal-pressure waterproof insulated connector being applied in battery. In FIG. 13, AR illustrates the application mode of the horizontal-pressure waterproof insulated connector in one connecting object, and BR shows that in another connecting object.

As shown in FIG. 12, when the horizontal-pressure waterproof insulated connector is connected, the two hollow waterproof rings 32 contact with each other to form the isolating cavity with the shell 31 to isolate the two moving conductors 34, under such situation, the moving conductors 34 are separate from the two contracts 33. The preliminary contact status of the horizontal-pressure waterproof insulated connector is shown in FIG. 14. The pressure is continued. Then the hollow waterproof rings 32 forms the isolating cavity with the shell 31 and are deformed. The two moving conductors 34 contact with and press on each other to enable the hollow waterproof rings 32 to form the gating isolate component with the moving conductors 34. The elasticity provided by dielectric elastomer 35 is overcome, and the two moving conductors 34 contact with the two contacts 33 to realize the waterproof and insulated connection. The final contact status of the horizontal-pressure waterproof insulated connector is shown in FIG. 15.

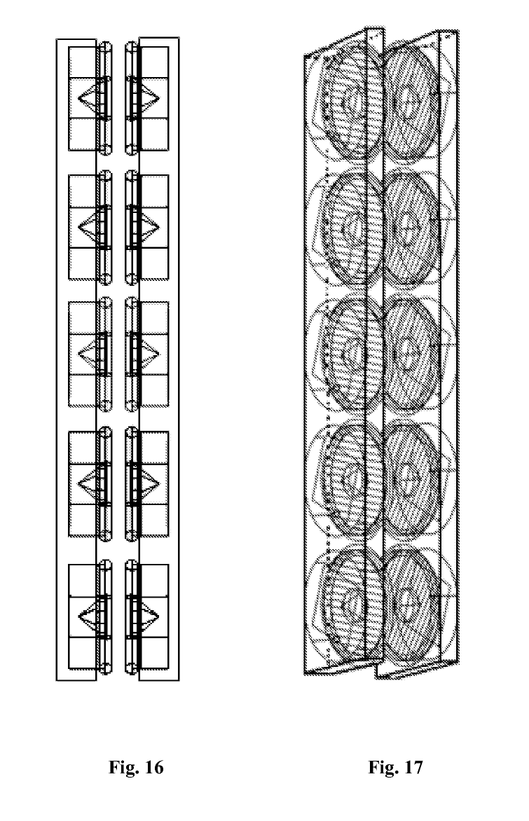

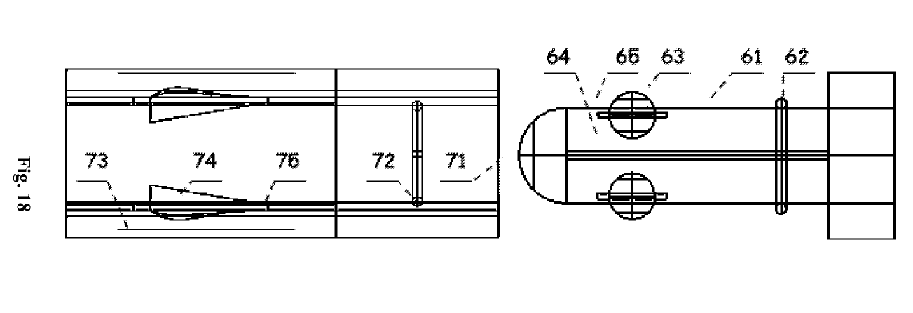

As for the embodiment of the multi-line application of the horizontal-pressure waterproof insulated connector, it can be realized by the parallel connection of horizontal-pressure waterproof insulated connectors. The multi-line application schematic diagrams are as shown in FIG. 16 and FIG. 17.

Side-pressure waterproof insulated connector embodiment of the invention

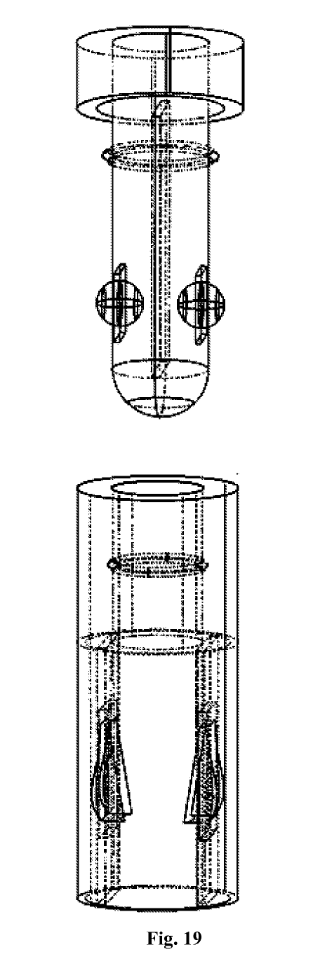

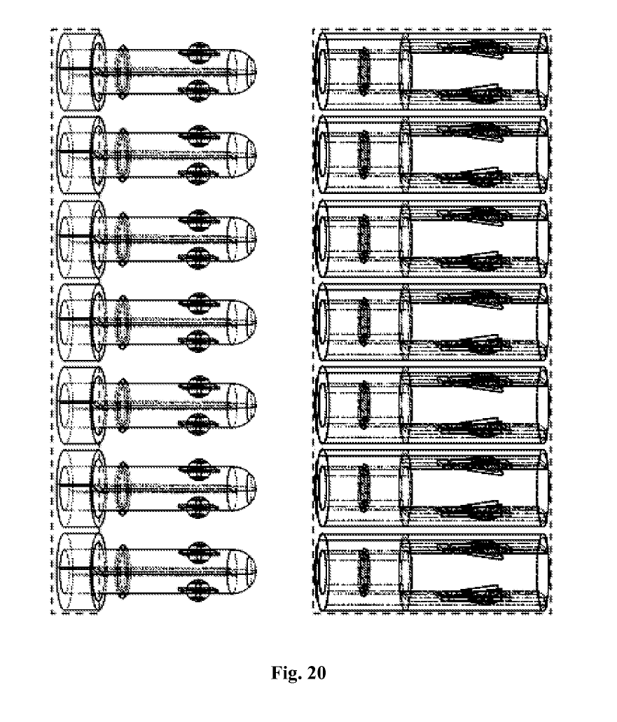

The side-pressure waterproof insulated connector, as shown in FIG. 18, includes shell 71, hollow waterproof ring 72, contact 73, moving conductor 74, and dielectric elastomer 75. Its plug consists of shell 61, hollow waterproof ring 62, contact 63, moving conductor 64, and dielectric elastomer 65. The structure of the side-pressure waterproof insulated connector is clearly shown in FIG. 19, its stereogram.

When the side-pressure waterproof insulated connector is connected, hollow waterproof ring 62 and hollow waterproof ring 72 contact with each other to form the isolating cavity with the shell 61 and the shell 71 to isolate the moving conductor 64 and the moving conductor 74, under such situation, the moving conductor 64 and the moving conductor 74 are separate from the contract 63 and the contract 73. The pressure is continued. Then conductor 64 and conductor 74 contact with and press on each other to enable dielectric elastomer 65, dielectric elastomer 75 and conductor 64, conductor 74 to form the gating isolate component with the moving conductors 34. The elasticity provided by dielectric elastomer 65 and dielectric elastomer 75 is overcome, and conductor 64, conductor 74 contact with the contract 63 and the contract 73 to realize the waterproof and insulated connection.

As for the embodiment of the multi-line application of the side-pressure waterproof insulated connector, it can be realized by the parallel connection of horizontal-pressure waterproof insulated connectors of the said embodiment. The multi-line application schematic diagram is as shown in FIG. 9.

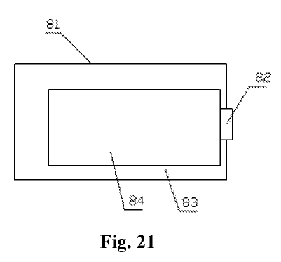

One specific embodiment of the invention, as shown in FIG. 21, is to apply the said waterproof insulated connector in specific electric equipment to realize its waterproof function. The waterproof cavity is formed by the waterproof insulation layer 81 and the shell of the waterproof insulated connector 82 to enfold the electric equipment 84. Then, the interface of the electric equipment 84 connect with the outside via the waterproof insulated connector 82. One specific example of the embodiment. A waterproof mobile or player is enfolded in the waterproof insulation layer 81, and connected with the outside interface via the said waterproof insulated connector 82, which can not only ensure the electric connection between the electric equipment and the outside world, but also fully guarantee the waterproof function of the equipment.

All features, methods, or steps publicized in the specification, except the mutually exclusive features and/or steps, can be combined in any way.

Any feature publicized in the specification (including any attached claims, abstract and drawings), unless specifically described, can be replaced by alternative features of the same performance or similar aims. Namely, unless specifically described, each feature is only one example of a series equivalent or similar features.

The invention is not limited to the specific embodiments described herein. The invention can be expanded to any new feature, combination, method, or step in the progress disclosed in the specification.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A type of waterproof insulated connector, which is characterized in that: such waterproof insulated connector consists of a gating isolate component made of conductor and dielectric elastomer, isolate contacts of the gating isolate components, and an isolating cavity.
The gating isolate component isolates passing of water and other media and solely allows conduction of electricity through the conductor. In addition, the component may be subject to elastic deformation to move the moving conductor within the elastic deformation range of the dielectric elastomer, so as to realize disconnection and connection between the moving conductor and contact. Contact connects with the object with which the interface connects. The isolating cavity is composed of an elastic deformation device made of a solid body and an elastomer and surrounds the connector.

2. The waterproof insulated connector as claimed in claim 1, which is characterized in that: when the dielectric elastomer in the said gating isolate component is pushed by a force less than the push pressure, it remains in the preliminary balance position; when it is pushed by a force larger than the push pressure, it remains in the final balance position and isolates water or other media from contacting with the objects to be contacted.

3. The waterproof insulated connector as claimed in claim 1, which is characterized in that: the isolating cavity is deformed as the hollow water rings undergoes elastic deformation when connected, which isolates conductors. Conductors exert pressure on each other to push forward the gating isolate component to enable the contact of the plug and the socket to conduct via conductors.

4. The waterproof insulated connector as claimed in claim 1, which is characterized in that, the said isolating cavity consists of a shell and a elastomeric seal at the opening of the shell. A contact is installed in the shell and connects with the object with which the interface connects. The dielectric elastomer of the gating isolate component is fixed at the opening of the shell, and conductors are fixed on the elastomer and pass through it, which can contact or disconnect with the contact with the deformation of the dielectric elastomer. The gating isolate component and the shell embrace the contact completely.

5. The type of electrical equipment that includes the waterproof insulated connector as claimed in claim 3, which is characterized in that, the interface of the electric equipment connects with other equipment by the waterproof insulated connector; a waterproof cavity formed by waterproof insulation layer and shell of the waterproof insulated connector enfold the electric equipment.
